(19) United States
(12) Patent Application Publication
(10) Pub. No.: US 2021/0231801 A1
(43) Pub. Date: Jul. 29, 2021

(54) MONITORING DEVICE FOR USE WITH AN ALERT MANAGEMENT PROCESS

(71) Applicant: ProTek Technologies, Inc., Kennesaw, GA (US)

(72) Inventor: David Gordon Allen, Acworth, GA (US)

(21) Appl. No.: 17/160,943

(22) Filed: Jan. 28, 2021

Related U.S. Application Data
(60) Provisional application No. 62/966,596, filed on Jan. 28, 2020.

(51) Int. Cl. G01S 15/89; H04N 7/18; G08B 25/00

(52) U.S. Cl. CPC G01S 15/8993; G08B 25/009; H04N 7/181

(57) ABSTRACT

Embodiments included herein are directed towards an apparatus and method for use with an alert management system. Embodiments may include scanning, using an imaging device including radio frequency imaging based on frequency-modulated continuous-wave radar. The imaging device may include ultrasonic imaging capabilities and metal detecting capabilities. Embodiments may include detecting a metallic object associated with an individual and capturing an image of both the individual and the detected metallic object. Embodiments may further include sending a warning signal to a nearest access point which transmits the information to a network and processing the information by the software or application at a local security point.

### CROSS-REFERENCE TO RELATED APPLICATIONS

This application claims the benefit of the following U.S. Provisional Application No.: 62/966,596, filed on Jan. 28, 2020; the entire contents of which are incorporated herein by reference.

### TECHNICAL FIELD

The present disclosure generally applies to the field of security.

### BACKGROUND

Security and safety are an essential facet of any business. Especially in the hospitality industry, a guest will always expect a safe place to stay. This expectation of safety is becoming an increasingly important expectation for the employees as well as the guests. Personal safety has become one of the most debilitating workplace stress factors for housekeeping staff today in the hospitality industry. Housekeeping staff and other employees who work alone or in vulnerable areas must deal with the potential for personal harm on a daily basis.

Employees need a quick way to notify the appropriate personnel of unsafe situations. Especially in locations, such as hotel rooms or bathrooms, where traditional security measures, such as security cameras, cannot be implemented, employees need to be able to send an alert to the appropriate personnel of their location, quickly and precisely.

In an effort to reduce incidents of violence in the hospitality industries and in workplaces generally, everyone is encouraged to report suspicious activity and to seek help quickly to resolve potential threats. However, conventional alert management systems are unable to quickly and efficiently report an emergency or provide an alert to others who can help.

### SUMMARY

In one or more embodiments of the present disclosure, a monitoring device for use with an alert management system is provided. The device may include an imaging device including radio frequency imaging based upon, at least in part, frequency-modulated, continuous-wave radar. The imaging device may include ultrasonic imaging capabilities and a metal detector.

One or more of the following features may be included. The frequency-modulated, continuous-wave radar may be used to provide a distance measurement. The frequency-modulated, continuous-wave radar may be used to provide a speed measurement. The metal detector may be configured to detect and identify an image of a metal object. The device may include a stepper motor configured to move one or more sensors along a predefined axis. The one or more sensors may be associated with the metal detector and are configured to scan an area to identify an obfuscated metal item. The device may include at least one processor configured to communicate with an emergency alert systems. The at least one processor may be configured to capture an image and transmit the image over a network. The at least one processor may determine whether to capture the image based upon, at least in part, detection of a metallic object. The at least one processor may be configured to communicate with one or more client handheld devices.

In another implementation, a method for use with an alert management system is provided. The method may include scanning, using an imaging device including radio frequency imaging based on frequency-modulated continuous-wave radar. The imaging device may include ultrasonic imaging capabilities and metal detecting capabilities. The method may include detecting a metallic object associated with an individual and capturing an image of both the individual and the detected metallic object. The method may further include sending a warning signal to a nearest access point which transmits the information to a network and processing the information by the software or application at a local security point.

One or more of the following features may be included. The frequency-modulated, continuous-wave radar may be used to provide a distance measurement and/or a speed measurement. The metal detector may be configured to detect and identify an image of a metal object. The method may include moving, via a stepper motor, one or more sensors along a predefined axis. The one or more sensors may be associated with the metal detector and are configured to scan an area to identify an obfuscated metal item. The method may include at least one processor configured to communicate with an emergency alert systems. The method may include capturing an image and transmitting the image over a network. The at least one processor may determine whether to capture the image based upon, at least in part, detection of a metallic object. The at least one processor may be configured to communicate with one or more client handheld devices.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

Embodiments of the present disclosure are described with reference to the following figures.

FIG. 1 is a diagrammatic view of a distributed computing network including a monitoring device according to an embodiment of the present disclosure;

FIG. 2 illustrates a method of using a monitoring device within a personnel security network;

FIG. 3 illustrates a system diagram according to an embodiment of the present disclosure; and

FIG. 4 illustrates a monitoring device according to an embodiment of the present disclosure.

Like reference symbols in the various drawings may indicate like elements.

### DETAILED DESCRIPTION

Schools, airports and other locations usually apply either portable or walk through metal detectors or handheld scanners to identify restricted and prohibited objects and metals. Embodiments of the present disclosure are directed towards a next-generation security device and camera designed and developed to ensure safety around the building by detecting all the restricted items.

The discussion below is directed to certain implementations. It is to be understood that the discussion below is only for the purpose of enabling a person with ordinary skill in the art to make and use any subject matter defined now or later by the patent “claims” found in any issued patent herein.

It is specifically intended that the claimed combinations of features not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

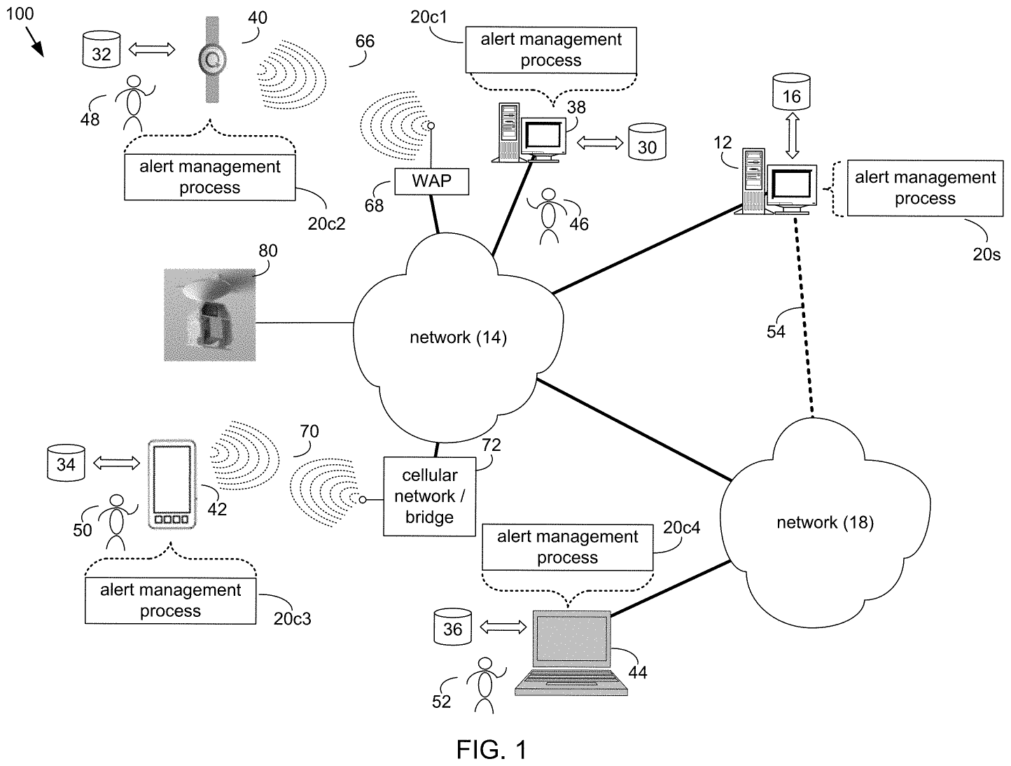

Referring to the example implementation of FIG. 1, there is shown alert management process 20. Alert management process 20 may be implemented as a server-side process, a client-side process, or a hybrid server-side/client-side process.

For example, alert management process 20 may be implemented as a purely server-side process via alert management process 20s. Alternatively, alert management process 20 may be implemented as a purely client-side process via one or more of alert management process 20c1, alert management process 20c2, alert management process 20c3, and alert management process 20c4. Alternatively still, alert management process 10 may be implemented as a hybrid server-side/client-side process via alert management process 20s in combination with one or more of alert management process 20c1, alert management process 20c2, alert management process 20c3, and alert management process 20c4. Accordingly, alert management process 10 as used in this disclosure may include any combination of alert management process 20s, alert management process 20c1, alert management process 20c2, alert management process 20c3, and alert management process 20c4.

Alert management process 20s may be a server application and may reside on and may be executed by computing device 12, which may be connected to network 14 (e.g., the Internet, a local area network, or combination thereof). Examples of computing device 12 may include, but are not limited to: a personal computer, a server computer, a series of server computers, a mini computer, a mainframe computer, or a cloud-based computing network.

The instruction sets and subroutines of alert management process 20s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of alert management processes 20c1, 20c2, 20c3, 20c4 may include but are not limited to a corporate user interface, a web browser, or a specialized application (e.g., an application running on e.g., the Android tm platform or the iOS tm platform). The instruction sets and subroutines of alert management processes 20c1, 20c2, 20c3, 20c4, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Examples of storage devices 30, 32, 34, 36 may include but are not limited to: hard disk drives; RAID devices; random access memories (RAM); read-only memories (ROM), and all forms of flash memory storage devices.

Examples of client electronic devices 38, 40, 42, 44 may include, but are not limited to: personal computer 38; specialty devices such as alert device 40; smartphone 42 or other data enabled cellular phone; laptop computer 44; a notebook computer (not shown); a server computer (not shown); a dedicated network device (not shown); and a tablet computer (not shown).

Client electronic devices 38, 40, 42, 44 may each execute an operating system, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

Users 46, 48, 50, 52 may access alert management process 20 directly through network 14 or through secondary network 18. Further, alert management process 10 may be connected to network 14 through secondary network 18, as illustrated with link line 54.

The various client electronic devices (e.g., client electronic devices 38, 40, 42, 44) may be directly or indirectly coupled to network 14 (or network 18). For example, alert device 40 is shown wirelessly coupled to network 14 via wireless communication channels 66 established between alert device 40 and wireless access point (i.e. WAP) 68, which is shown directly coupled to network 14. Further, smartphone 42 is shown wirelessly coupled to network 14 via wireless communication channels 70 established between smartphone 42 and cellular network/bridge 72, which is shown directly coupled to network 14. Additionally, personal computer 38 is shown directly coupled to network 14 via a hardwired network connection. Additionally, laptop computer 44 is shown directly coupled to network 18 via a hardwired network connection.

WAP 68 may be, for example, an IEEE 802.11a, 802.11b, 802.11g, 802.11n, Wi-Fi, and/or Bluetooth device that is capable of establishing wireless communication channel 66 between alert device 40 and WAP 68. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth® is a telecommunications industry specification that allows e.g., mobile phones, computers, personal digital assistants and internet of things (IoT) devices to be interconnected using a short-range wireless connection. In some implementations WAP 68 may be incorporated into or associated with a specialty device (such as imaging device 80) as will be discussed in greater detail below.

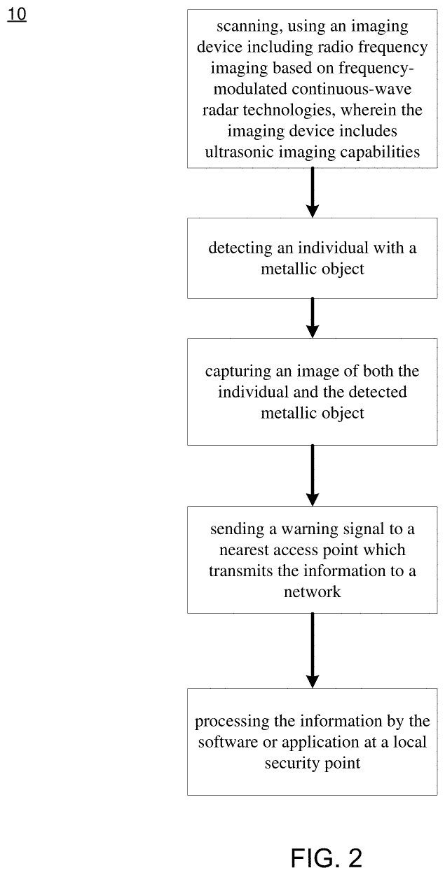

Schools, airports and other locations usually apply either portable or walk through metal detectors or handheld scanners to identify restricted and prohibited objects and metals. Referring to FIGS. 2-4 and as will be discussed in greater detail below, embodiments of the present disclosure introduce a next-generation imaging device and security camera designed and developed to ensure safety around the building by detecting all the restricted items.

Walk through detector solutions take up much space, are easy to identify and are targeted specifically on the individual who walks through them, while portable or handheld ones are sometimes risky for the individuals. Embodiments of the present disclosure, on the other hand, provide a new type of imaging device 80 that captures the prohibited items (e.g. metallic objects, weapons, etc.) within meters and sends push notifications via networks 14, 18, etc. to the relevant authorities.

In some embodiments, once imaging device 80 scans and detects the individual with the prohibited item it takes a picture of both the individual and the detected prohibited item. The imaging device may then send the relevant warning signal to the nearest access point which may transmit the information to the networks 14, 18, etc. The gathered data then may be processed by the software or application at the local security point.

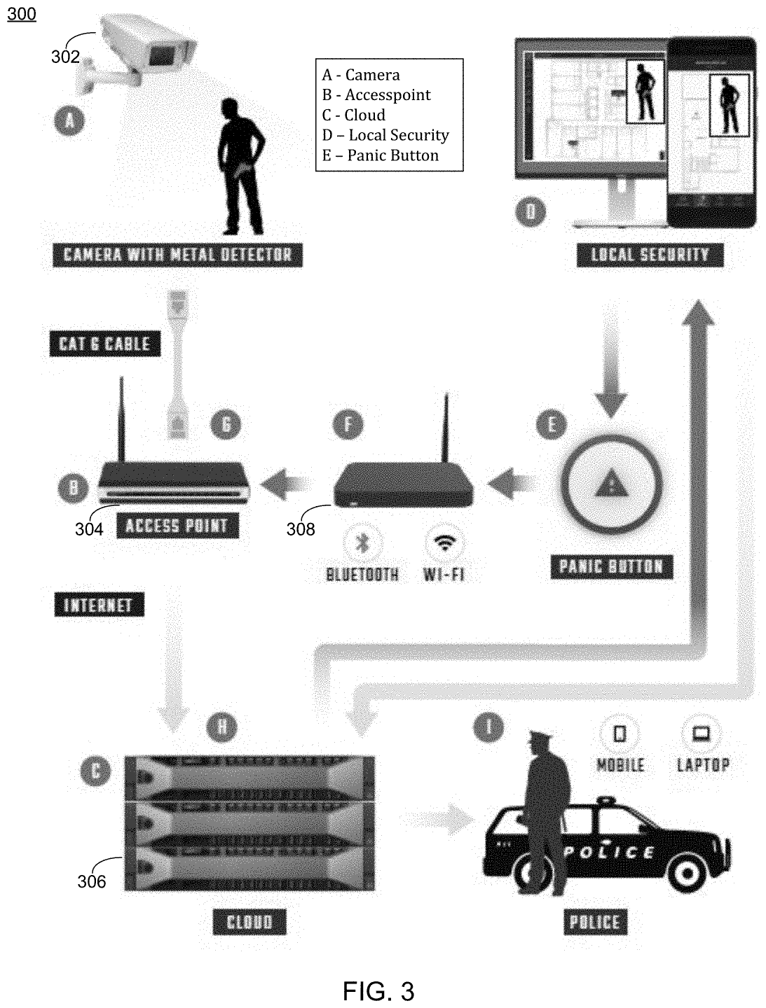

In some embodiments, based on the received data a security officer of the institution with one push of a button may send a panic alert to the whole building. This alert may be transmitted via the access point or using any other suitable approach. The panic alert may also be sent to contact the nearest police to inform on the accident as shown in FIG. 3.

In some embodiments, imaging device 80 may include a combination of three technologies, which together executed, provide a higher level of protection. These technologies may include, but are not limited to, RF imaging based on frequency-modulated continuous-wave (“FMCW”) radar technologies, ultrasonic imaging, metal detectors, etc.

Continuous-wave radar (CW radar) is a type of radar system where a known stable frequency continuous wave radio energy may be transmitted and then received from any reflecting objects. Individual objects may be detected using the Doppler effect, which may cause the received signal to have a different frequency than the transmission, allowing it to be detected by filtering out the transmitted frequency.

Doppler-analysis of radar returns can allow the filtering out of slow or non-moving objects, thus offering immunity to interference from large stationary objects and slow-moving clutter. This makes it particularly useful for looking for objects against a background reflector, for instance, allowing a high-flying aircraft to look for aircraft flying at low altitude against the background of the surface. Because the very strong reflection off the surface may be filtered out, the much smaller reflection from a target may still be seen.

Frequency-modulated continuous-wave radar (FMCW)—also called continuous-wave frequency-modulated (CWFM) radar generally refers to a short-range measuring radar set capable of determining distance. This may increase reliability by providing a distance measurement along with a speed measurement, which may be essential when there is more than one source of reflection arriving at the radar antenna. This kind of radar is often used as radar altimeter that may measure the exact height during the landing procedure of aircraft. It may also be used as a wave radar, early-warning radar and/or proximity sensor. Doppler shift may not always be required for detection when FM is used.

In some embodiments, the transmitted signal of a known stable frequency continuous wave varies up and down in frequency over a fixed period of time by a modulating signal. Accordingly, the frequency difference between the receive signal and the transmit signal increases with delay, and hence with distance. This may blur the Doppler signal. Echoes from a target may then be mixed with the transmitted signal to produce a beat signal which will give the distance of the target after demodulation. A variety of modulations is possible, the transmitter frequency can slew up and down, for example, as a sine wave, sawtooth wave, triangle wave, square wave, etc.

In some embodiments, imaging device 80 may include RF imaging based on these FMCW radar technologies. Imaging device 80 may include a camera and a built-in frequency-modulated continuous-wave radar solution to provide a distance measurement along with a speed measurement. Due to its design and the proper frequency selection, imaging device 80 may be configured to detect and identify the image of the metal even through walls.

In some embodiments, imaging device 80 may include ultrasonic imaging capabilities. Ultrasonic imaging is profoundly used in medicine to examine the human inner organs. Embodiments included herein may utilize a modified version of the technology as in medical devices to ensure high-distance coverage.

In some embodiments, imaging device 80 may include metal detector capabilities. For example, imaging device 80 may include metal detector technology with one or more stepper motors that may be configured to move metal detector sensors in a strictly decided axis. In some embodiments, imaging device 80 may be configured to scan the area with enough distance to identify hidden metals and metal shaped items.

In some embodiments, imaging device 80 may include not only the camera but also embedded software. Accordingly, embodiments included herein may support mobile applications for both iOS and Android OS; web applications, and additionally, cloud server computing capabilities. The software ensures seamless activity of the camera, and may be directly integrated into the existing emergency system of the organization. The software may directly send one or more push notifications to the relevant authorities to inform on possible prohibited item or metal. Individuals who have the associated app installed in their iOS or Android devices may receive the pictures of the trespasser as well as the image of the prohibited item. Accordingly, embodiments included herein may provide details on the exact location of the camera on the floorplan of the building.

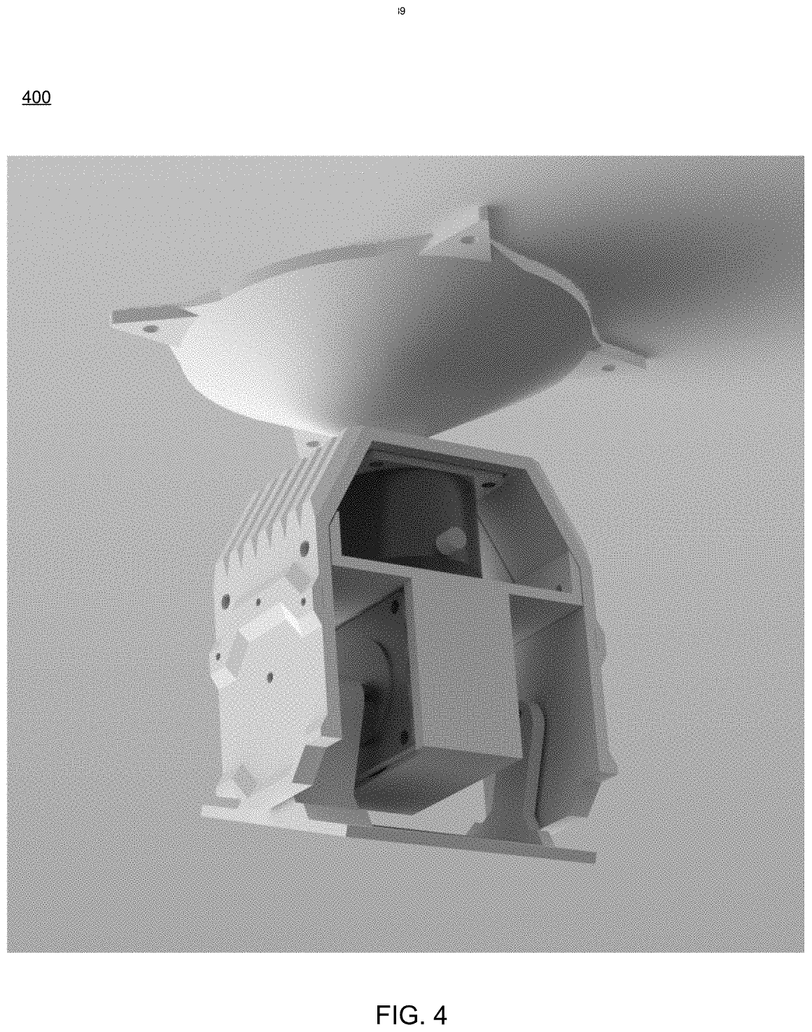

Referring again to FIG. 3, a system diagram associated with embodiments of the present disclosure is provided. In some embodiments, imaging device 302 may be associated with any portion of a building (e.g., affixed to a ceiling as is shown in FIG. 4). Imaging device 302 may be configured to detect a metallic object associated with an individual. Upon detecting such an object, imaging device 302 may transmit a signal to a wireless access point 304. Wireless access point 304 may be configured to transmit and receive the signal to local security using any suitable approach, some of which may include, but are not limited to, bluetooth, Wi-Fi, wired networks. In some embodiments, an employee or any suitable individual may trigger an alert via a panic button, which may be sent to local security, who may be located in or near the building. In some embodiments, access point 304 may transmit the signal to the cloud, which may also communicate with local security, police or both.

Referring again to FIG. 4, an embodiment showing an example imaging device 400 is provided. In some embodiments, imaging device 400 may include radio frequency imaging. More particularly, imaging device 400 may include frequency-modulated, continuous-wave radar capabilities, ultrasonic imaging capabilities and the metal detection discussed above. The frequency-modulated, continuous-wave radar may be used to provide, inter alia, both distance and speed measurements. Imaging device 400 may constructed out of any suitable material, including but not limited to, metal, plastics, and combinations thereof. In some embodiments, an antenna may be associated with imaging device 400 and may include either monostatic or bistatic antennas. Imaging device 400 may be located using any suitable approach and may be affixed to the building. In some embodiments, imaging device 400 may be used as a standalone device.

The flowchart and block diagrams in the figures illustrate the architecture, functionality, and operation of possible implementations of systems and methods and according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used in any embodiment described herein, the term “circuitry” may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment or embodiment herein may be implemented in software, firmware, hardwired circuitry and/or any combination thereof.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A monitoring device for use with an alert management system comprising:
an imaging device including radio frequency imaging based upon, at least in part, frequency-modulated, continuous-wave radar, wherein the imaging device includes ultrasonic imaging capabilities and a metal detector.

2. The monitoring device of claim 1, wherein the frequency-modulated, continuous-wave radar is used to provide a distance measurement.

3. The monitoring device of claim 1, wherein the frequency-modulated, continuous-wave radar is used to provide a speed measurement

4. The monitoring device of claim 1, wherein the metal detector is configured to detect and identify an image of a metal obj

5. The monitoring device of claim 1, further comprising a stepper motor configured to move one or more sensors along a predefined axis.

6. The monitoring device of claim 6, wherein the one or more sensors are associated with the metal detector and are configured to scan an area to identify an obfuscated metal item.

7. The monitoring device of claim 1, further comprising at least one processor configured to communicate with an emergency alert systems.

8. The monitoring device of claim 1, further comprising at least one processor configured to capture an image and transmit the image over a network.

9. The monitoring device of claim 1, wherein the at least one processor determines whether to capture the image based upon, at least in part, detection of a metallic object.

10. The monitoring device of claim 9, wherein the at least one processor is configured to communicate with one or more client handheld devices.

11. A method for use with an alert management system comprising:
scanning, using an imaging device including radio frequency imaging based on frequency-modulated continuous-wave radar technologies, wherein the imaging device includes ultrasonic imaging capabilities;
detecting an individual with a metallic object;
capturing an image of both the individual and the detected metallic object;
sending a warning signal to a nearest access point which transmits the information to a network; and
processing the information by the software or application at a local security point.

12. The method of claim 11, wherein the frequency-modulated, continuous-wave radar is used to provide a distance measurement.

13. The method of claim 11, wherein the frequency-modulated, continuous-wave radar is used to provide a speed measurement

14. The method of claim 11, wherein the metal detector is configured to detect and identify an image of a metal object.

15. The method of claim 11, further comprising a stepper motor configured to move one or more sensors along a predefined axis.

16. The method of claim 15, wherein the one or more sensors are associated with the metal detector and are configured to scan an area to identify an obfuscated metal item.

17. The method of claim 11, further comprising at least one processor configured to communicate with an emergency alert systems.

18. The method of claim 11, further comprising at least one processor configured to capture an image and transmit the image over a network.

19. The method of claim 11, wherein the at least one processor determines whether to capture the image based upon, at least in part, detection of a metallic object.

20. The method of claim 19, wherein the at least one processor is configured to communicate with one or more client handheld devices.
